(19) United States
(12) Patent Application Publication
(10) Pub. No.: US 2016/0180816 A1
(43) Pub. Date: Jun. 23, 2016

(54) LIQUID CRYSTAL DISPLAY AND METHOD FOR DRIVING THE SAME

(71) Applicant: Samsung Display Co., Ltd., Yongin-city (KR)

(72) Inventors: Hyun Sik HWANG, Hwaseong-si (KR); Bong Im Park, Asan-si (KR); Ik Hyun Ahn, Hwaseong-si (KR); Woo Joo Lee, Seoul (KR)

(21) Appl. No.: 14/711,302

(22) Filed: May 13, 2015

(30) Foreign Application Priority Data
Dec. 19, 2014 (KR) 10-2014-0184618

(51) Int. Cl. G09G 5/18; G09G 3/36

(52) U.S. Cl. CPC G09G 5/18; G09G 3/3674; G09G 2330/021; G09G 2300/0426

(57) ABSTRACT

A liquid crystal display has a first transistor, a first capacitor, a second transistor, a liquid crystal element, and a third transistor. A controller may be configured to alternately, based on a period of a horizontal signal, apply a common voltage through a common voltage line at a high level and a low level.

### CROSS-REFERENCE TO RELATED APPLICATION

This application claims priority from and the benefit of Korean Patent Application No. 10-2014-0184618, filed on Dec. 19, 2014, which is hereby incorporated by reference for all purposes as if fully set forth herein.

### BACKGROUND

1. Field

Exemplary embodiments relate to a liquid crystal display and a method for driving the same.

2. Discussion

Compared to other display devices, liquid crystal displays (LCDs) can have the advantages of small size, thin shape, and low power consumption, and thus LCDs have been used in notebook computers, office automation devices, and audio/video devices. An active matrix type liquid crystal display, which uses a thin film transistor (TFT) as a switching element, can be suitable for displaying a dynamic image. The liquid crystal display creates a visible image through adjustment of light permeability of liquid crystal cells on a liquid crystal panel in accordance with grayscale values of a data signal. However, in the case where a direct current (DC) voltage is applied to the liquid crystal cells arranged on the liquid crystal panel for a long time, the light permeation characteristics may deteriorate. That is, a DC fixation phenomenon occurs, and this may cause afterimages to occur on an image that is displayed on the liquid crystal panel.

An inversion type liquid crystal display, which performs inversion of a data voltage that is supplied to the liquid crystal cells of the display panel on the basis of a common voltage Vcom, has been proposed as a technique to prevent DC fixation. The common voltage Vcom may be maintained as a DC voltage of a predetermined level, and the data voltage may be applied in a manner that a positive voltage and a negative voltage, relative to the common voltage Vcom, alternate with each other. That is, in order to drive the inversion type liquid crystal display, the voltage level of the data voltage should be changed since the common voltage Vcom is applied as the constant voltage of a predetermined level. Accordingly, since it is required that the applied data voltage is higher than the common voltage Vcom over a predetermined voltage level and the data voltage swings between the positive and negative voltages on the basis of the common voltage Vcom, the amplitude of the data voltage which is a difference between the positive and negative voltages becomes a twice as much as liquid crystal driving voltage. As a result, the power consumption increases in proportion to a square of the amplitude of the data voltage.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a liquid crystal display and a method for driving a liquid crystal display which can reduce power consumption.

Additional aspects will be set forth in the detailed description which follows, and, in part, will be apparent from the disclosure, or may be learned by practice of the inventive concept.

According to exemplary embodiments, a liquid crystal display includes a first transistor, associated with a pixel, having a gate electrode connected to a scan line, an electrode connected to a data line, and another electrode connected to a first node; a first capacitor having one terminal connected to the first node and the other terminal connected to a common voltage line; a second transistor having a gate electrode connected to a first control signal line, an electrode connected to the first node, and another electrode connected to a second node; a liquid crystal element having one terminal connected to the second node and the other terminal connected to the common voltage line; a third transistor having a gate electrode connected to a second control signal line, an electrode connected to the second node, and another electrode connected to the common voltage line. A controller may be configured to alternately, based on a period of a horizontal signal, apply a common voltage through the common voltage line at a high level and a low level.

According to exemplary embodiments, a liquid crystal display includes a display panel including pixels in matrix form; a scan driving unit sequentially providing scan signals to the pixels; a data driving unit providing a data voltage to the pixels; and a voltage generation unit alternately, based on a period of a horizontal signal, providing a common voltage at a high level and a low level to the pixels. A pixel includes a liquid crystal element and a first capacitor, and the first capacitor is configured to be charged with a voltage that corresponds to a difference between the data voltage and the common voltage according to the scan signals, and the pixel is configured to distribute the voltage that is charged in the first capacitor to the liquid crystal element according to a first control signal that is simultaneously provided to the pixels.

According to exemplary embodiments, a method for driving a liquid crystal display including a display panel having pixels in matrix form, a pixel including a liquid crystal element, at least one transistor driving the liquid crystal element, and a first capacitor, includes charging a voltage in the first capacitors of the pixels; initializing the liquid crystal elements; and distributing the voltage charged in the first capacitors to the liquid crystal elements, wherein a voltage that corresponds to a difference between a data voltage provided from a data driving unit and a common voltage is charged in the first capacitor, and the common voltage is alternately, based on a period of a horizontal signal, at a high level and a low level.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram of a liquid crystal display according to one or more exemplary embodiments.

FIG. 2 is a circuit diagram of one pixel of a liquid crystal display according to one or more exemplary embodiments.

FIG. 3 is a timing diagram of a liquid crystal display according to one or more exemplary embodiments.

FIGS. 4, 5, and 6 are circuit diagrams explaining the operation of one pixel for each period of a liquid crystal display according to one or more exemplary embodiments.

FIG. 7 is a schematic diagram illustrating a data voltage that is input in a state where a common voltage is fixed according to one or more exemplary embodiments.

FIG. 8 is a schematic diagram illustrating a data voltage that is actually input to a liquid crystal element according to one or more exemplary embodiments.

FIG. 9 is a schematic diagram illustrating a data voltage that is input in a state where a common voltage swings according to one or more exemplary embodiments.

FIG. 10 is a block diagram of a liquid crystal display according to one or more exemplary embodiments.

FIG. 11 is a circuit diagram of pixels of a liquid crystal display according to one or more exemplary embodiments.

FIG. 12 illustrates an embodiment of a method for driving a liquid crystal display

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

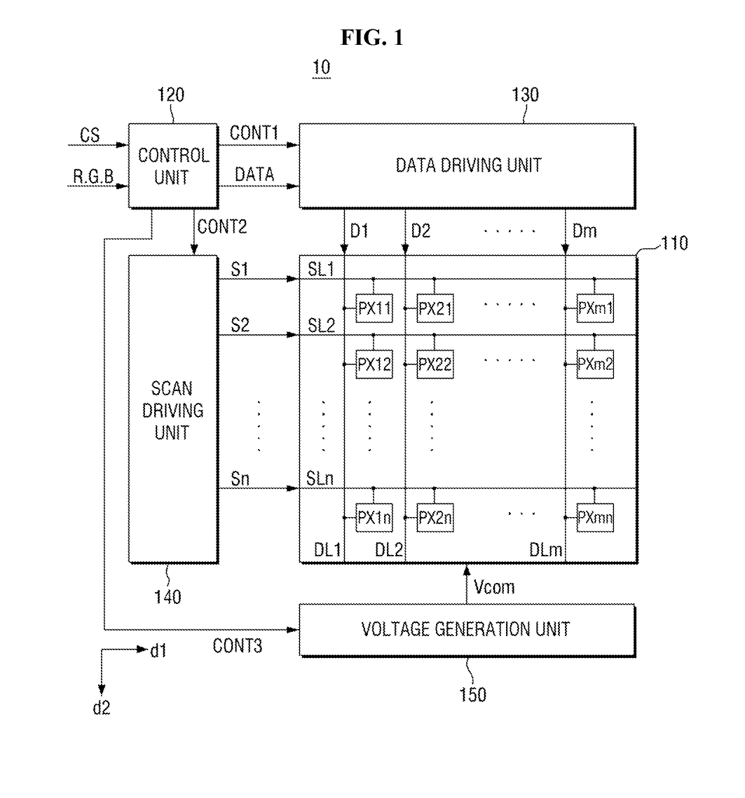

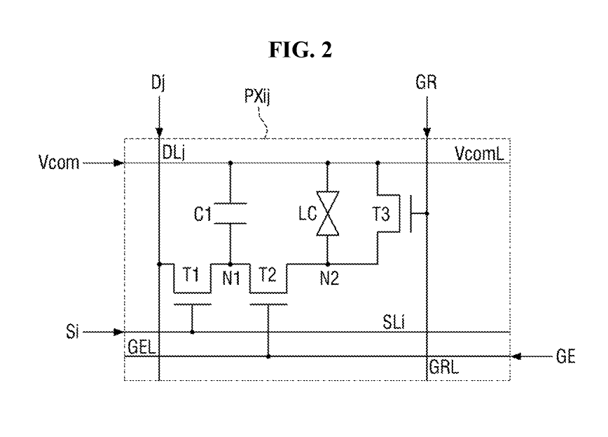

FIG. 1 is a block diagram of a liquid crystal display according to one or more exemplary embodiments, and FIG. 2 is a circuit diagram of one pixel of a liquid crystal display according to one or more exemplary embodiments. According to one or more exemplary embodiments, the response speed of liquid crystals can be improved and power consumption can be reduced.

Referring to FIGS. 1 and 2, liquid crystal display 10 includes display panel 110, control unit 120, data driving unit 130, scan driving unit 140, and voltage generation unit 150.

Display panel 110 may be a panel for displaying an image. Display panel 110 may include a first substrate, a second substrate that faces the first substrate, and a liquid crystal layer interposed between the first substrate and the second substrate. That is, display panel 110 may be a liquid crystal panel. Here, the first substrate may be an array substrate on which a plurality of pixels to be described later and lines connected thereto are formed, and the second substrate may be an encapsulation substrate that covers the first substrate. A common electrode may be formed on a surface of the second substrate that faces the first substrate. The common electrode may form a vertical electric field together with a pixel electrode formed on the surface of the first substrate, and an arrangement of liquid crystal molecules of the liquid crystal layer may be adjusted according to the electric field. That is, a common voltage Vcom may be applied to the common electrode, and a data voltage to be described later may be applied to the pixel electrode. Accordingly, an electric field that corresponds to the electric potential difference between the voltages may be formed on each pixel, but is not limited thereto. The common electrode may be formed on the first substrate, and may form a horizontal electric field together with the pixel electrode of the first substrate to adjust the arrangement of the liquid crystal molecules. Here, the light permeability of the display panel may be controlled according to the arrangement of the liquid crystal molecules.

Display panel 110 may include a plurality of scan lines SL1 to SLn, a plurality of data lines DL1 to DLm that cross the plurality of scan lines SL1 to SLn, and a plurality of pixels PX each of which is connected to one of the plurality of scan lines SL1 to SLn and one of the plurality of data lines DL1 to DLm. As described above, the plurality of scan lines SL1 to SLn, the plurality of data lines DL1 to DLm, and the plurality of pixels PX may be formed on the first substrate of display panel 110. The plurality of pixels PX may be arranged in the form of a matrix. The plurality of scan lines SL1 to SLn may be shaped to extend in a row direction, and may be substantially in parallel to each other. The plurality of scan lines SL1 to SLn may include first to n-th scan lines SL1 to SLn that are arranged in order. The plurality of data lines DL1 to DLm may cross the plurality of scan lines SL1 to SLn, respectively. That is, the plurality of data lines DL1 to DLm may be shaped to extend in a second direction d2 that is perpendicular to a first direction d1, and may be substantially in parallel to each other.

Each of the plurality of pixels PX may be connected to one of the plurality of scan lines SL1 to SLn and one of the plurality of data lines DL1 to DLm. The plurality of pixels PX may receive data voltages D1 to Dm that are applied to the data lines DL1 to DLm that are connected in correspondence to scan signals S1 to Sn that are provided from the connected scan lines SL1 to SLn. That is, each pixel PX may include a transistor that is turned on by the scan signal to apply the data voltages D1 to Dm to the pixel electrode.

Control unit 120 may receive a control signal CS and video signals R, G, and B from an external system. Here, the video signals R, G, and B include luminance information of the plurality of pixels PX. The luminance may have a predetermined number of gray levels, for example, 1024, 256, or 64 gray levels. The control signal CS may include a vertical sync signal Vsync, a horizontal sync signal Hsync, a data enable signal DE, and a clock signal CLK. The control unit 120 may generate first to third driving control signals CONT1 to CONT3 and video data DATA according to the video signals R, G, and B and the control signal CS. Control unit 120 may divide the video signals R, G, and B in the unit of a frame according to the vertical sync signal Vsync, and may divide the video signals R, G, and B in the unit of a scan line according to the horizontal sync signal Hsync to generate the video data DATA. Further, control unit 120 may compensate for the generated video data DATA and transfer the compensated video data DATA to data driving unit 130. Control unit 120 may transfer the second driving control signal CONT2 to scan driving unit 140, and transfer the third driving control signal CONT3 to voltage generation unit 150.

Scan driving unit 140 may be connected to display panel 120 through the plurality of scan lines SL1 to SLn. The second driving control signal CONT2 may be a signal that controls output of the scan signals S1 to Sn. Scan driving unit 140 may sequentially apply the plurality of scan signals S1 to Sn to the plurality of scan lines SL1 to SLn. For this, scan driving unit 140 may include shift registers (not illustrated) for sequentially applying the plurality of scan signals S1 to Sn to the scan lines SL1 to SLn.

Data driving unit 130 may be composed of shift registers, latches, and a digital-to-analog converter DAC. Data driving unit 130 may receive the first driving control signal CONT1 and the video data DATA from control unit 120. Data driving unit 130 may select a reference voltage to correspond to the first driving control signal CONT1, and may convert the video data DATA of a digital waveform that is input in correspondence to the selected reference voltage into a plurality of data voltages D1 to Dm. Data driving unit 130 may output the generated data voltages D1 to Dm to display panel 110.

Voltage generation unit 150 may supply an operating power of display device 10 and may provide the common voltage Vcom to display panel 110. Further, voltage generation unit 150 may provide the reference voltage (not illustrated) to the data driving unit and may provide a gate-on voltage (not illustrated) or a gate-off voltage (not illustrated) to scan driving unit 140.

Referring to FIG. 2, display panel 110 may further include a common voltage line VcomL through which the common voltage Vcom may be applied to the respective pixels PX, a second control signal wiring GRL through which a second control signal GR may be applied, and a first control signal wiring GEL through which a first control signal GE may be applied. The second control signal wiring GRL may extend in the same direction as the direction of the data line, and the first control signal wiring GEL may extend in the same direction as the direction of the scan line, but are not limited thereto. A plurality of second control signal wirings GRL and first control signal wirings GEL may be formed to transfer the second control signal GR and the first control signal GE to the connected pixels PX.

FIG. 2 schematically illustrates the circuit configuration of any one of the plurality of pixels included in the display unit 110. That is, a pixel that is connected to the i-th scan line SLi and the j-th data line DLj is exemplarily illustrated, and the remaining pixels may have the same configuration as the configuration of the exemplary pixel. However, the circuit configuration of each pixel PX is not limited thereto. Each pixel PX may include a first transistor T1, a first capacitor C1, a second transistor T2, a third transistor T3, and a liquid crystal element LC. The first transistor T1 may include a gate electrode connected to the i-th scan line SLi, an electrode connected to the j-th data line DLj, and another electrode connected to a first node N1. The first transistor T1 may be turned on by the scan signal Si of the gate-on voltage to apply the data voltage Dj applied to the data line DLj to the first node N1. The first transistor T1 may be a switching transistor that selectively provides the data voltage Dj to a driving transistor. Here, the first to third transistors T1, T2, and T3 may be n-channel field effect transistors. That is, the first transistor T1 may be turned on by the scan signal of a high-level voltage, and may be turned off by the scan signal of a low-level voltage, but is not limited thereto. Any or all of the first to third transistor T1, T2, and T3 may be p-channel field effect transistors.

One terminal of the first capacitor C1 may be connected to the first node N1, and the other terminal thereof may be connected to the common voltage line VcomL. That is, the first capacitor C1 may be connected between the first node N1 and the common voltage line VcomL. A voltage that corresponds to a voltage difference between both terminals of the first capacitor C1 may be charged in the first capacitor C1.

The second transistor T2 may be controlled by the first control signal GE. The second transistor T2 may include a gate electrode connected to the first control signal wiring GEL, one electrode connected to the first node N1, and the other electrode connected to a second node N2. The second transistor T2 may electrically connect the first node N1 and the second node N2 to each other based on the first control signal GE.

The second node N2 may be connected to the liquid crystal element LC. Specifically, the second node N2 may be connected to the pixel electrode (not illustrated) of the liquid crystal element LC. The liquid crystal element LC may include the pixel electrode, the common electrode arranged to face the pixel electrode, and the liquid crystal layer arranged between the pixel electrode and the common electrode. The common electrode of the liquid crystal element LC may be connected to the common voltage line VcomL. That is, the common voltage of a predetermined level may be applied to the common electrode of the liquid crystal element LC. As the first node N1 and the second node N2 are connected to each other, the voltage of the first capacitor C1 may be distributed and supplied to the pixel electrode of the liquid crystal element LC. Here, the liquid crystal element LC may form one electric field due to the voltage difference between the common electrode and the pixel electrode, and may be considered as one liquid crystal capacitor. That is, the voltage charged in the first capacitor C1 may be shared by the liquid crystal element LC according to the capacitance of the first capacitor C1 and the capacitance of the liquid crystal capacitor. This will be described in more detail later.

The third transistor T3 may be controlled by the second control signal GR. The third transistor T3 may include a gate electrode connected to the second control signal wiring GRL, one electrode connected to the second node N2, and the other electrode connected to the common voltage line VcomL. The third transistor T3 may be turned on by the second control signal GR to initialize the voltage of the liquid crystal element LC to the common voltage Vcom.

Hereinafter, the operation of the liquid crystal display according to one or more exemplary embodiments will be described in more detail.

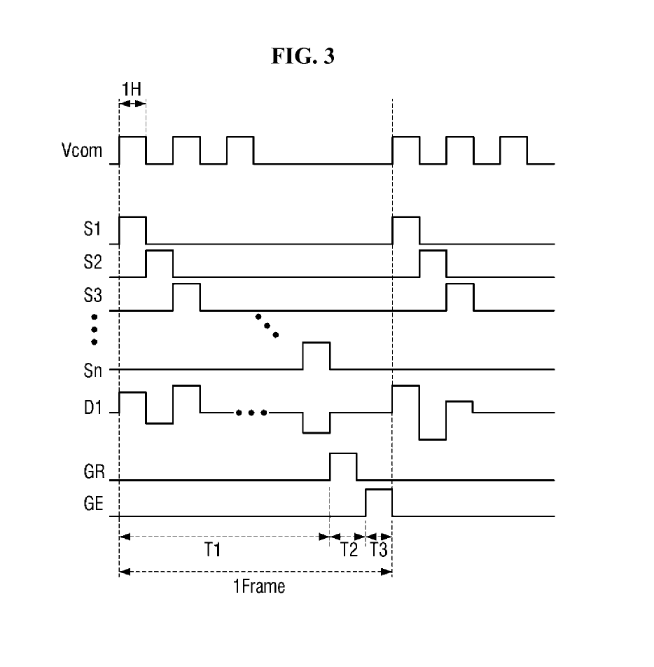

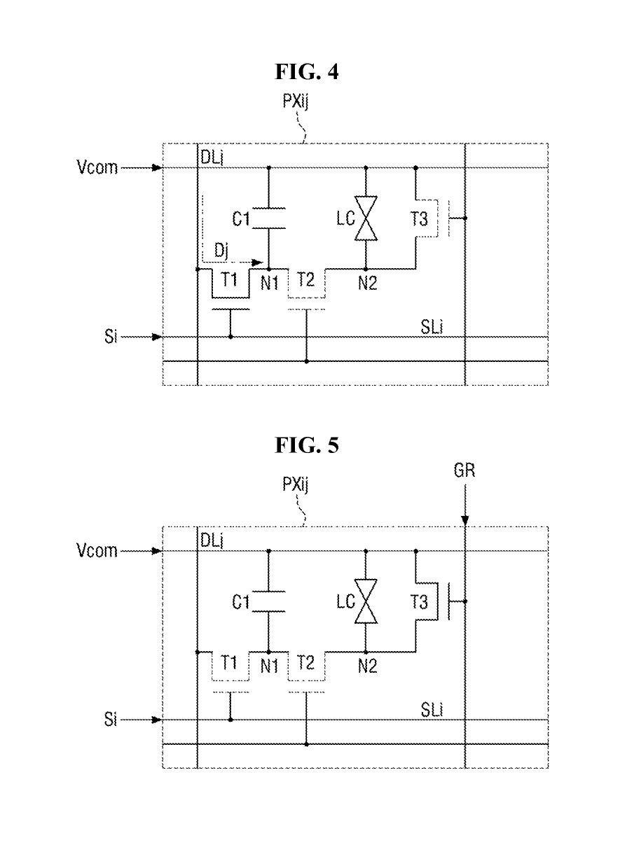

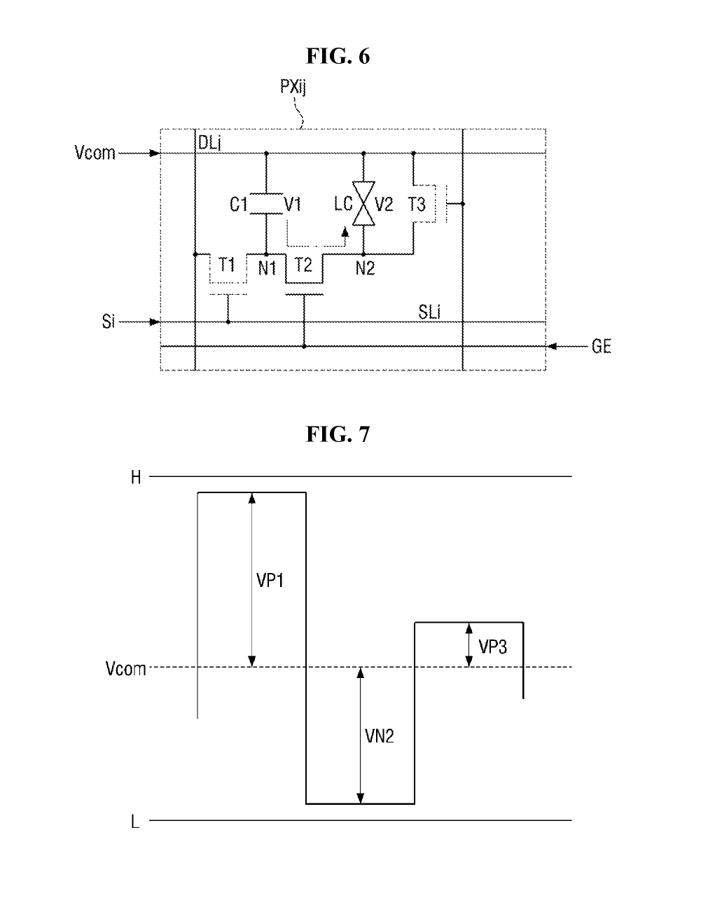

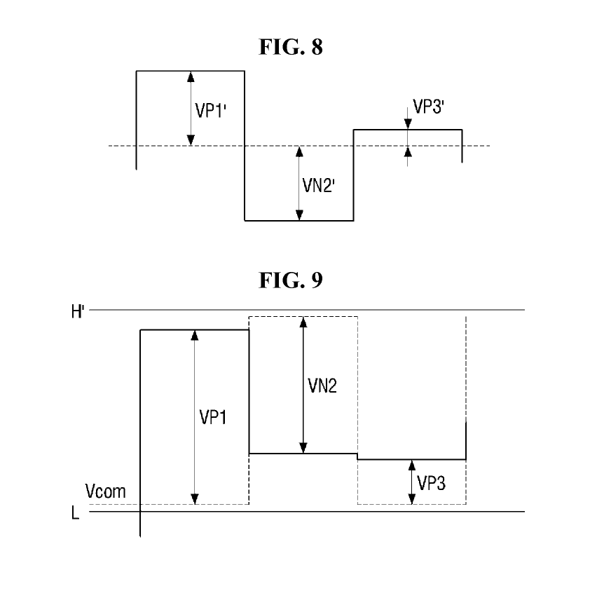

FIG. 3 is a timing diagram of a liquid crystal display according to one or more exemplary embodiments, and FIGS. 4 to 6 are circuit diagrams explaining the operation of one pixel for each period of a liquid crystal display according to one or more exemplary embodiments. FIG. 7 is a schematic diagram illustrating a data voltage that is input in a state where a common voltage is fixed, and FIG. 8 is a schematic diagram illustrating a data voltage that is actually input to a liquid crystal element, and FIG. 9 is a schematic diagram illustrating a data voltage that is input in a state where a common voltage swings according to one or more exemplary embodiments.

Referring to FIGS. 3 to 9, one frame period of the liquid crystal display according to this embodiment may include a first period t1, a second period t2, and a third period t3. The first period t1 may be a period in which the data voltage is input, and the second period t2 may be an initialization period. The third period t3 may be a distribution period of the data voltage. Here, FIGS. 4 to 6 provide circuit diagrams to explain the operation of one pixel during the first period t1, the second period t2, and the third period t3 respectively.

During the period t1 in which the data voltage is input, the scan signals S1 to Sn may be sequentially provided. The first transistor T1 of each pixel PX may be turned on in correspondence to the scan signal and may transfer the data voltage to the first node N1. Hereinafter, explanation will be made around the pixel PXij as illustrated in FIGS. 4 to 6. That is, the first transistor T1 may be turned on by the i-th scan signal Si, and may transfer the j-th data voltage Dj to the first node N1. A voltage that corresponds to the voltage difference between the first node N1 and the common voltage Vcom may be charged in the first capacitor C1.

During the second period t2, the third transistor T3 may be turned on, and the first transistor T1 and the second transistor T2 may be turned off. The third transistor T3 may be turned on by the second control signal GR. Here, the second control signal GR may be simultaneously provided to the respective pixels PX, and the third transistors T3 of a group of pixels PX, or all the pixels PX, of the display panel 110 may be simultaneously turned on. As the third transistor T3 is turned on, the liquid crystal element LC may be initialized to the common voltage Vcom. That is, the second control signal GR may be a global reset signal that initializes the liquid crystal elements LC of the plurality of pixels PX. In this case, the common voltage Vcom may be a voltage that realigns the liquid crystal molecules of the liquid crystal layer. Exemplarily, the common voltage may be ground or 0V, but is not limited thereto.

During the third period t3, only the second transistor T2 may be turned on. The second transistor T2 may be turned on by the first control signal GE. Here, the first control signal GE may be simultaneously provided to the respective pixels PX, and the second transistors T2 of a group of pixels PX, or all the pixels PX, of the display panel 110 may be simultaneously turned on. As the second transistor T2 is turned on, the voltage that is charged in the first capacitor C1 may be distributed to the liquid crystal element LC through the second transistor T2. The charge that is charged in the first capacitor C1 may be shared by the liquid crystal capacitor. That is, liquid crystal display 10 according to this embodiment has the structure that entirely initializes the plurality of pixels and makes the plurality of pixels simultaneously emit light, and thus in the case of displaying a stereoscopic image, a black image may not be inserted between a left-eye image and a right-eye image. That is, even if the left-eye image and the right-eye image are successively displayed, the display quality can be prevented from being deteriorated through simultaneous display of the images. Further, since the black image is not inserted, the entire luminance can be increased, and the waste of the power that is caused by driving of a backlight more brightly for luminance compensation can be prevented. That is, according to liquid crystal display 10 according to this embodiment, the display quality is improved and the power consumption is reduced.

Here, if it is assumed that the voltage charged in the first capacitor C1 is V1 and the voltage charged in the liquid crystal element LC is V2, an electric field that corresponds to the voltage V2 may be formed in the liquid crystal element LC, and thus the arrangement of the liquid crystal molecules may be changed. The voltage V2 that is charged in the liquid crystal element LC may be determined according to charging capacity CS_{CAP} of the first capacitor C1 and charging capacity LC_{CAP} of the liquid crystal element LC. That is, the voltage that is charged in the first capacitor C1 may be distributed according to the charging capacity CS_{CAP} of the first capacitor C1 and the charging capacity LC_{CAP} of the liquid crystal element LC. Specifically, the voltage V2 that is charged in the liquid crystal element LC may be calculated as in Equation 1 below.

$$V 2 = \frac{{CS}_{CAP}}{{CS}_{CAP} + {LC}_{CAP}} * V 1 \qquad [ Equation 1 ]$$

Here, CS_{CAP} means the charging capacity of the first capacitor C1, and LC_{CAP} means the charging capacity of the liquid crystal element LC.

As illustrated in FIGS. 7 and 8, if the voltages charged in the first capacitor C1 are VP1, VN2, and VP3, the voltages that actually exert an influence on the liquid crystal layer may be VP1′, VN2′, and VP3′, which are lower than VP1, VN2, and VP3, respectively. That is, since the voltage charged in the first capacitor C1 is distributed and applied to the liquid crystal element LC, voltages charged in the first capacitor C1 will be higher than the voltages that actually exert an influence on the liquid crystal layer. Here, as illustrated in FIG. 7, if the common voltage Vcom is fixed to a constant level, the data voltage with higher level should be provided to charge the first capacitor C1 with high-level voltage. Here, H denotes the highest voltage level of the data voltage, and L denotes the lowest voltage level of the data voltage. If it is assumed that the highest voltage level, i.e., the voltage level of the common voltage Vcom, is 15V, and the positive voltage VP1 is +15V, the data voltage of 30V should be provided to apply the voltage VP1. Further, if it is assumed that the negative voltage VN2 is −12V, the data voltage of 3V should be provided to charge the first capacitor with VN2. The providing of high voltage and high voltage deviation may increase the power consumption of a driving IC and may cause other additional problems due to generation of high heat.

Voltage generation unit 150 of display device 10 according to this embodiment can output the common voltage Vcom that is at a low level and a high level alternately by a period of one horizontal time (1H). Specifically, in the first period t1, the common voltage Vcom may be at the low level and the high level alternately by a period of one horizontal time (1H), and may be at low level in the second and third periods t2 and t3. Here, one horizontal time (1H) may mean a time in which one scan signal is output. That is, the common voltage Vcom may be provided at high level to correspond to the first scan signal S1, and may be provided at low level to correspond to the second scan signal S2. Exemplarily, the low level may be 0V, and the high level may be 15V, but are not limited thereto. A positive voltage may be applied to the first capacitor C1 of each pixel PX to correspond to the low level of the common voltage Vcom, and a negative voltage may be applied to the first capacitor C1 of each pixel PX to correspond to the high level of the common voltage Vcom. Here, for inversion driving, the voltage level of the common voltage Vcom may be changed by frames. That is, in the present frame, a positive data voltage that corresponds to the low-level common voltage Vcom may be applied to the pixels, and in the next frame, a negative data voltage that corresponds to the high-level common voltage Vcom may be applied to the pixels. Here, since the voltage level of the common voltage is changed to correspond to the scan signal, the polarity inversion according to this embodiment may be of a horizontal inversion type.

As the common voltage Vcom swings to be output, the level of the data voltage that is necessary to charge the first capacitor C1 may be decreased. As illustrated in FIG. 9, the maximum voltage level H′ of the data voltage according to this embodiment may be lower than the maximum voltage level H of the data voltage in a state where the common voltage Vcom is fixed. Exemplarily, in a state where the common voltage Vcom of a low level (0V) is provided, the voltage level of the data voltage that is necessary to charge VP1 (15V) in the first capacitor C1 may be 15V. As the maximum voltage level H′ is lowered, the deviation of the provided data voltage may be decreased.

According to liquid crystal display 10, even if the data voltage is not provided at high voltage level, the common voltage Vcom swings to be provided by the period of one horizontal time (1H), and thus the first capacitor C1 can be charged with sufficiently high voltage level. Accordingly, liquid crystal display 10 according to this embodiment can prevent the power consumption from being increased and can prevent heating phenomenon from occurring as the level of the data voltage is heightened.

Further, the liquid crystal display may include a period, in which a backlight power is turned off for a predetermined time, between the second period t2 and the third period t3. That is, as the backlight power is turned off, motion blurring phenomenon, which may be generated in the case where a dynamic motion image, such as a sports image, is displayed, can be reduced. That is the liquid crystal display according to this embodiment can provide improved display quality.

Hereinafter, a liquid crystal display according to one or more exemplary embodiments will be described.

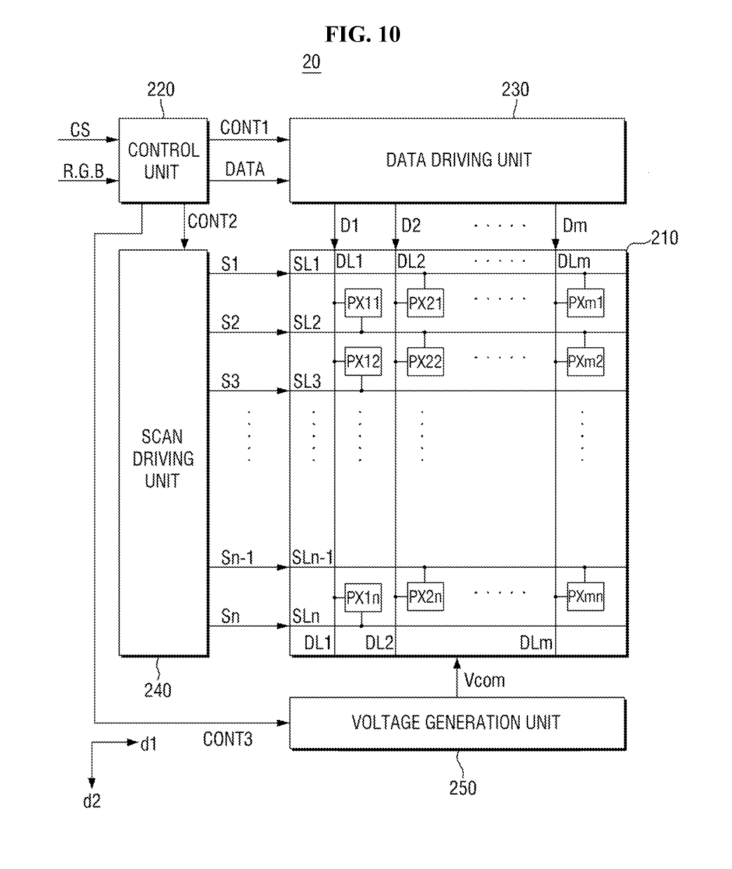

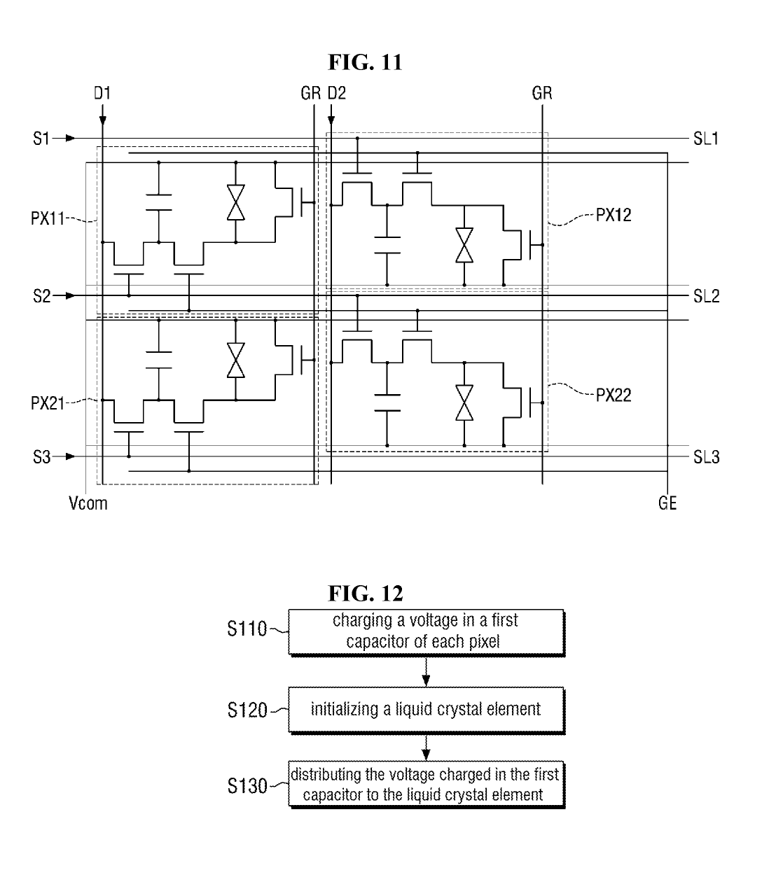

FIG. 10 is a block diagram of a liquid crystal display according to one or more exemplary embodiments, and FIG. 11 is a circuit diagram of pixels of a liquid crystal display according to one or more exemplary embodiments.

Referring to FIGS. 10 and 11, liquid crystal display 20 according to this embodiment includes display panel 210, control unit 220, data driving unit 230, scan driving unit 240, and voltage generation unit 250.

Display panel 210 may include a plurality of pixels PX. Two pixels that are arranged in line among the plurality of pixels PX may be connected to different scan lines. That is, two pixels PX11 and PX12 that are arranged in line in a first direction d1 may be connected to a second scan line S2 and a first scan line S1 respectively. That is, a gate electrode of a first transistor of pixel PX12 that is arranged in line with pixel PX11 in an extension direction of one scan line may be connected to another scan line S1 that is successively arranged with the scan line S2 to which pixel PX11 is connected. Further, pixels PX11 and PX21 that are arranged in line in a second direction d2 may be connected to the second scan line S2 and a third scan line S3 respectively. That is, the plurality of pixels PX of the display panel 210 may be connected to cross the scan lines up and down. Here, when liquid crystal display 20 according to this embodiment is operated in a similar manner as liquid crystal display 10 of FIGS. 1 to 9, two pixels that are arranged in line in one frame may have different polarities. That is, in liquid crystal display 20 according to this embodiment, the scan lines are arranged to cross the pixels, and thus dot inversion driving can be provided.

Rather than repeat explanation of liquid crystal display 20 for features similar to the explanation of the liquid crystal display 10 of FIGS. 1 to 9, duplicate explanation will be omitted.

A liquid crystal display according to an exemplary embodiment includes a display panel that has a plurality of pixels in matrix form and each of the plurality of pixels includes a liquid crystal element, at least one transistor that drives the liquid crystal element, and a first capacitor. FIG. 12 illustrates an embodiment of a method for driving a liquid crystal display. Here, the liquid crystal display may be the liquid crystal display of FIGS. 1 to 9 or the liquid crystal display of FIGS. 10 and 11, and thus the duplicate explanation thereof will be omitted.

Referring to FIG. 12, the method for driving a liquid crystal display according to this embodiment includes charging a voltage in a first capacitor C1 of each pixel (S110), initializing a liquid crystal element LC (S120), and distributing the voltage charged in the first capacitor C1 to the liquid crystal element LC (S130).

First, the voltage is charged in the first capacitor C1 (S110).

Charging the voltage may be implemented by applying a data voltage to each pixel. Scan signals S1 to Sn may be sequentially provided to each pixel, and a first transistor T1 of each pixel PX may be turned on according to the scan signals to apply the data voltage to a first node N1. A voltage that corresponds to a voltage difference between the first node N1 and a common voltage Vcom may be charged in the first capacitor C1. That is, the charging the voltage in the first capacitor C1 may be sequentially performed with respect to the plurality of pixels to correspond to the scan signals. Here, the common voltage Vcom may be provided in a manner that a high level and a low level alternate by a period of one horizontal time (1H). A positive voltage may be applied to the first capacitor C1 of each pixel PX to correspond to the low level of the common voltage Vcom, and a negative voltage may be applied to the first capacitor C1 of each pixel PX to correspond to the high level of the common voltage Vcom. That is, according to the method for driving a liquid crystal display, even if the data voltage is not provided at high voltage level, the common voltage Vcom swings to be provided by the period of one horizontal time (1H), and thus the first capacitor C1 can be charged with sufficiently high voltage level. According to the method for driving a liquid crystal display, the power consumption can be prevented from being increased and heating phenomenon can be prevented from occurring as the level of the data voltage is heightened.

Then, the liquid crystal element LC is initialized (S120).

The third transistor T3 may be turned on by the second control signal GR. Here, the second control signal GR may be simultaneously provided to the respective pixels PX, and the third transistors T3 of all the pixels PX of the display panel 110 may be simultaneously turned on. As the third transistor T3 is turned on, the liquid crystal element LC may be initialized to the common voltage Vcom. That is, the second control signal GR may be a global reset signal that initializes the liquid crystal elements LC of the plurality of pixels PX. In this case, the common voltage Vcom may be a voltage that realigns the liquid crystal molecules of the liquid crystal layer. Exemplarily, the common voltage may be 0V, but is not limited thereto. In charging the voltage in the first capacitor C1 (S110), the common voltage Vcom may be provided in a manner that the high level and the low level alternate by a period of one horizontal time, and in initializing the liquid crystal element LC (S120), the common voltage Vcom may be provided at low level.

The voltage that is charged in the first capacitor C1 is distributed (S130).

The second transistor T2 may be turned on by the first control signal GE. Here, the first control signal GE may be simultaneously provided to the respective pixels PX, and the second transistors T2 of all the pixels PX of the display panel 110 may be simultaneously turned on. As the second transistor T2 is turned on, the voltage that is charged in the first capacitor C1 may be distributed to the liquid crystal element LC through the second transistor T2. The charge that is charged in the first capacitor C1 may be shared by the liquid crystal capacitor. The voltage V2 that is charged in the liquid crystal element LC may be determined according to charging capacity CS_{CAP} of the first capacitor C1 and charging capacity LC_{CAP} of the liquid crystal element LC. That is, the voltage that is charged in the first capacitor C1 may be distributed according to the charging capacity CS_{CAP} of the first capacitor C1 and the charging capacity LC_{CAP} of the liquid crystal element LC following the Equation 1 as mentioned above. An electric field that corresponds to the voltage V2 may be formed in the liquid crystal element LC, and thus the arrangement of the liquid crystal molecules may be changed. That is, according to the method for driving a liquid crystal display, the plurality of pixels are entirely initialized and are made to simultaneously emit light. In the case of displaying a stereoscopic image, a black image does not have to be inserted between a left-eye image and a right-eye image. That is, even if the left-eye image and the right-eye image are successively displayed, the display quality can be prevented from being deteriorated through simultaneous display of the images. Further, since the black image is not inserted, the entire luminance can be increased, and the waste of the power that is caused by driving of a backlight more brightly for luminance compensation can be prevented. That is, according to the method for driving a liquid crystal display, the display quality is improved and the power consumption is reduced.

Other explanation of liquid crystal display 20 may be substantially the same as the explanation of the liquid crystal display 10 of FIGS. 1 to 7, and thus the duplicate explanation thereof will be omitted.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A liquid crystal display, comprising:
a first transistor, associated with a pixel, comprising a gate electrode connected to a scan line, an electrode connected to a data line, and another electrode connected to a first node;
a first capacitor comprising one terminal connected to the first node and the other terminal connected to a common voltage line;
a second transistor comprising a gate electrode connected to a first control signal line, an electrode connected to the first node, and another electrode connected to a second node;
a liquid crystal element comprising one terminal connected to the second node and the other terminal connected to the common voltage line;
a third transistor comprising a gate electrode connected to a second control signal line, an electrode connected to the second node, and another electrode connected to the common voltage line; and
a controller configured to alternately, based on a period of a horizontal signal, apply a common voltage through the common voltage line at a high level and a low level.

2. The liquid crystal display of claim 1, wherein the first transistor is configured to be turned on by a scan signal provided through the scan line to apply a data voltage provided through the data line to the first node, and
wherein the first capacitor is configured to be charged to a voltage that corresponds to a difference between the common voltage and the data voltage.

3. The liquid crystal display of claim 2, wherein the first capacitor is configured to be charged to a negative voltage during a period when the common voltage is applied at a high level, and
wherein the first capacitor is configured to be charged to a positive voltage during a period when the common voltage is applied at a low level.

4. The liquid crystal display of claim 2, wherein the second transistor is configured to be turned on by a first control signal provided through the first control signal line to distribute a voltage charged in the first capacitor to the liquid crystal element.

5. The liquid crystal display of claim 2, wherein the pixel is configured such that a voltage charged in the first capacitor is distributed to the liquid crystal element according to charging capacity of the first capacitor and charging capacity of the liquid crystal element.

6. The liquid crystal display of claim 1, further comprising a transistor associated with another pixel, arranged in line with the pixel associated with the first transistor in an extension direction of the scan line, wherein a gate electrode of the transistor associated with the another pixel is connected to the scan line.

7. The liquid crystal display of claim 1, further comprising a transistor associated with another pixel, arranged in line with the pixel associated with the first transistor in an extension direction of the scan line, wherein a gate electrode of the transistor associated with the another pixel is connected to another scan line that is successively arranged with the scan line.

8. The liquid crystal display of claim 1, wherein the controller is configured to apply the common voltage of a high level to the pixel and to apply the common voltage of a low level to another pixel arranged in line with the pixel in an extension direction of the data line.

9. The liquid crystal display of claim 1, wherein the third transistor is configured to be turned on by a second control signal that is provided through the second control signal line to initialize the liquid crystal element is initialized to the common voltage.

10. The liquid crystal display of claim 9, wherein the controller is configured to swing the common voltage between a high level and a low level, in correspondence with an output of the scan signal, when the first capacitor is charged, and to apply the common voltage at a low level when the liquid crystal element is initialized to the common voltage.

11. A liquid crystal display comprising:
a display panel including pixels in matrix form;
a scan driving unit sequentially configured to provide scan signals to the pixels;
a data driving unit configured to provide a data voltage to the pixels; and
a voltage generation unit alternately, based on a period of a horizontal signal, configured to provide a common voltage at a high level and a low level to the pixels,
wherein a pixel comprises a liquid crystal element and a first capacitor, the first capacitor is configured to be charged with a voltage that corresponds to a difference between the data voltage and the common voltage according to the scan signals, and the pixel is configured to distribute the voltage that is charged in the first capacitor to the liquid crystal element according to a first control signal that is simultaneously provided to the pixels.

12. The liquid crystal display of claim 11, wherein the first capacitor is configured to be charged to a negative voltage when the common voltage is provided at a high level, and
wherein the first capacitor is configured to be charged to a positive voltage when the common voltage is provided at a low level.

13. The liquid crystal display of claim 11, wherein the pixel is configured to distribute the voltage charged in the first capacitor to the liquid crystal element according to a charging capacity of the first capacitor and a charging capacity of the liquid crystal element.

14. The liquid crystal display of claim 11, wherein the liquid crystal element is configured to be initialized to the common voltage according to a second control signal that is simultaneously provided to the pixels.

15. The liquid crystal display of claim 14, wherein voltage generation unit is configured to swing the common voltage between a high level and a low level in accordance with an output of the scan signal when the first capacitor is charged and provides the common voltage at a low level when the liquid crystal element is initialized to the common voltage.

16. A method for driving a liquid crystal display including a display panel having pixels in matrix form, a pixel including a liquid crystal element, at least one transistor driving the liquid crystal element, and a first capacitor, the method comprising:
charging a voltage in the first capacitors of the pixels;
initializing the liquid crystal elements; and
distributing the voltage charged in the first capacitors to the liquid crystal elements,
wherein a voltage that corresponds to a difference between a data voltage provided from a data driving unit and a common voltage is charged in the first capacitor, and
the common voltage is alternately, based on a period of a horizontal signal, at a high level and a low level.

17. The method of claim 16, wherein a negative voltage is charged in the first capacitors when the common voltage is provided at a high level, and
a positive voltage is charged in the first capacitors when the common voltage is provided at a low level.

18. The method of claim 16, wherein the voltage that is charged in the first capacitors is distributed to the liquid crystal elements according to charging capacity of the first capacitors and charging capacity of the liquid crystal elements.

19. The method of claim 16, wherein the charging the voltage in the first capacitors is sequentially performed with respect to the pixels according to scan signals, and
the distributing the voltage charged in the first capacitors is simultaneously performed with respect to the pixels.

20. The method of claim 16, wherein the common voltage alternates between the high level and the low level when charging the voltage in the first capacitors, and the common voltage is provided at a low level when initializing the liquid crystal elements.
